(19) United States
(12) Patent Application Publication
(10) Pub. No.: US 2014/0185408 A1
(43) Pub. Date: Jul. 3, 2014

(54) BOTTOM SEISMIC SYSTEM

(71) Applicants: Vladimir Eduardovich KYASPER, St.Petersburg (RU); Evgeny Dmitrievich Lisitsyn, St.Petersburg (RU); Yury Georgievich Erofeev, Volzhskiy (RU); Andrej Vladimirovich Tulupov, Moscow (RU)

(72) Inventors: Vladimir Eduardovich KYASPER, St.Petersburg (RU); Evgeny Dmitrievich Lisitsyn, St.Petersburg (RU); Yury Georgievich Erofeev, Volzhskiy (RU); Andrej Vladimirovich Tulupov, Moscow (RU)

(21) Appl. No.: 13/851,288

(22) Filed: Mar. 27, 2013

(30) Foreign Application Priority Data
Dec. 28, 2012 (RU) RU201258380

(51) Int. Cl. G01V 1/38

(52) U.S. Cl. CPC G01V 1/3852
USPC 367/15

(57) ABSTRACT

A sea bottom station for registration of seismic waves with vertical and horizontal components, having a vertical axis, including—a submergible case with a lid and a bottom preferably twice thicker than the lid,—a geophone block, wherein one geophone registers the vertical component, the remaining geophones register the horizontal component and create geophone pairs being pairwise orthogonal-positioned, while the geophones of each such pair are located symmetrically to the vertical axis. The bottom station includes—a power supply unit formed of rechargeable batteries, circumferentially located and pairwise symmetrical relatively to the vertical axis. The bottom station may include a multi-channel registration unit,—a connector socket, a LED sensor,—vacuum and external pressure sensors,—an acoustic system having an electronic board connected to an antenna,—an angle-detector associated with—a compass whose indication direction coincides with a geophone pair's axis, and the compass' center is located on the vertical axis.

### CROSS-REFERENCE TO RELATED APPLICATION

This U.S. patent application claims priority under 35 U.S.C. 119 (a) through (d) from a Russian Federation patent application RU201258380 filed 28 Dec. 2012.

### FIELD OF THE INVENTION

The proposed invention relates to the field of survey geophysics, in particular, to the equipment for multi-component seismic measuring at the sea bottom for prognosis of hydrocarbon deposits and study of the structure of sedimentary layer.

### BACKGROUND OF THE INVENTION

Nowadays the seismic survey with the use of bottom systems, is rapidly developing, which allows for measuring not only longitudinal seismic waves, but also transversal seismic waves.

There is known a bottom seismic system designed by a Russian state scientific-production enterprise <<Sevmorgeo>> (advertisement booklet of “Sevmorgeo”). The system is encapsulated in a spherical hermetic case, containing geophones, a power source, a registration unit, and a control unit of an acoustic circuit breaker of the electrochemical type. The hermetic case ensures positive floatation of the system. For placing the system on the sea bottom, it is fastened with elastic (rubber) braids to a concrete load of a rectangular shape via the circuit breaker. Such design of the bottom system ensures a high technological suitability of the submerging—emerging operations, possibility of work at the depths up to 6000 meters, however, high positioning of transverse shear wave sensors relative to the bottom and elastic fastening of the system to the load reduces the system's sensitivity for the transversal waves.

A bottom system taught in a published patent application US20130028047 (herein also called a ‘prototype bottom system’) is considered a related art closest to the present invention. The prototype bottom system comprises: a cylindrical case with a rounded bottom and a convex lid; the case contains a registration unit with flash-memory, a compass, a power source, and a geophone block; a hydrophone mounted outside the case; a vacuum-port, a condition indicator, and a hermetic connector, covered with an elastic protector. The system structure ensures recharging of feeding elements and re-recording information from the flash-memory to an external data carrier via a hermetic connector without opening the system. The published patent application US20130028047 is hereby entirely incorporated by reference.

Design of the prototype bottom system allows for increasing the productivity of operation, ensures obtaining information through four channels. However, it has a number of disadvantages, diminishing its efficiency. Exemplarily, the rounding shape of cylindrical case reduces the area of contact with the sea bottom that affects accuracy of registration of transversal seismic waves. Further, the prototype structure doesn't ensure minimization and correction of influence of magnetic masses of the bottom system's units on the compass' indications. Another disadvantage of the aforementioned bottom system is absence of an acoustic system for determination of the system's coordinates on the seabed, which necessitates the use of an external acoustic navigation system.

### AIM AND BRIEF DESCRIPTION OF THE INVENTION

The primary aim of the present invention is the designing of a sea bottom seismic system (it can also be called a ‘bottom station’) being free of the aforementioned disadvantages, i.e. providing for minimum impact of magnetic masses of the system's elements on the compass' output indications (orientation in the Earth's magnetic field), and increasing the sensitivity of the bottom system. Other aims of the invention can be identified by a person skilled in the art upon learning the present disclosure. Without further analysis, the present disclosure will so fully reveal the gist of the invention that others can, by applying current knowledge, readily adapt it for various applications without omitting features that, from the standpoint of prior art, fairly constitutes essential characteristics of the generic or specific aspects of this invention.

In preferred embodiments, the inventive sea bottom seismic system (station) features:
(a) the bottom system is characterized with a vertical axis; the bottom system includes a submergible hermetic case (preferably of a cylindrical shape) made of essentially non-magnetic material (for example, of stainless steel or aluminum-magnesium alloy); the case comprises an upper lid, a bottom, and sidewalls, wherein the bottom is preferably at least twice thicker than the upper lid and the sidewalls; the case essentially houses all units of the bottom system;
(b) the bottom system includes a power supply unit formed of a plurality of rechargeable (accumulative) batteries, circumferentially located and pairwise symmetrical in relation to the system's vertical axis; a main digital data processor serving for communications with external systems;
(c) the bottom system includes a compass mounted within the case, and a geophone block comprising preferably five geophones for registration of transversal seismic shear waves, wherein a geophone registering the wave vertical component is mounted along the vertical axis of the bottom system, and the other four geophones registering the wave horizontal components are pairwise orthogonal-positioned, while the geophones of one such pair are located symmetrically in relation to the vertical axis of the bottom system; the geophone block is rigidly mounted on the bottom of the case, i.e. the geophone block is essentially positioned in the plane of the bottom; such structure of the geophone block significantly reduces the influence of the geophones' magnetic masses on the compass' indications. In some embodiments, the geophone block may optionally comprise an odd plurality of geophones, wherein one geophone is the one that registers the vertical component of transversal seismic waves, whereas the remaining geophones are pairwise orthogonal-positioned, while the geophones of each such pair are located symmetrically in relation to the vertical axis, and the remaining geophones register the horizontal component of transversal seismic waves;
(d) the bottom system includes a multi-channel registration unit based on a registration micro-processor with an analog-to-digital converter and a pre-amplifier for each data channel (see the published patent application US20130028047), the multi-channel registration unit is capable of recording seismic data; the multi-channel registration unit comprises: a nonvolatile flash-memory (preferably of at least a 16 Gb capacity, see the published patent application US20130028047), wherein the registration processor manages data recording into the flash-memory; and a high-accuracy internal clock based on a quartz generator (see the published patent application US20130028047); an angle-detector (preferably a three-component angle detector) associated with the compass; a vacuum sensor; an external pressure sensor; and a communication unit for communicating the bottom system with a corresponding module installed on a vessel that serves for setting up the bottom systems on the seabed and picking them up after operation.
(e) the bottom system includes an acoustic system that serves for determination of the bottom system's coordinates (location) on the seabed, and for transferring information on the bottom system's condition and the noise level via an acoustic channel. The acoustic system comprises an electronic board (serving essentially for processing the acoustic signals) connected with an acoustic antenna, preferably mounted on the upper lid of the case.

The aforementioned angle-detector, used for measuring of pitch, roll, and magnetic azimuth, is placed coplanar to the plane of the case's bottom (with is also the plane of the geophones), in such a way that the compass' indicating direction essentially coincides with the axis of one pair of the geophones, and the compass' center is located on the vertical axis of the bottom system. The angle-detector is capable of internal calibration for taking into account the influence of magnetic masses of the bottom system's elements.

The aforementioned vacuum sensor is intended for control of the system's water-tightness in the process of its preparation for operation, and during exploitation thereof. The aforementioned external pressure sensor is intended for control of the depth of the bottom system placement on the seabed, and registering of changes of the sea level during operation, especially, in tidal zones.

In preferred embodiments of the present invention, the following units are located on the outer surface of the case: a hydrophone; a vacuum-port; a connector socket serving for the bottom system initialization, data transferring from a flash-memory, and recharging the power supply unit; a LED sensor for control of the functional condition of the bottom system. All of the above enumerated units, except for the hydrophone, are provided with hermetical plugs, placed prior to submerging of the bottom system onto the seabed to prevent water leakage inside the case.

Preferably, the bottom system may include two connector sockets used for separation of data transferring and batteries charging to essentially prevent their interference. The bottom system preferably includes a sensor for functional control thereof; the functional control sensor can be represented by a multi-colored LED, connected via the main digital data processor with the vacuum sensor, the power supply unit, and the registration unit's processor.

All the elements mounted on the outer surface of the case are protected with a protector layer, preferably made of compound material, for example polyurethane or polyethylene, and having radial junction with the upper lid and the bottom of the case.

BRIEF DESCRIPTION OF DRAWINGS OF THE INVENTION

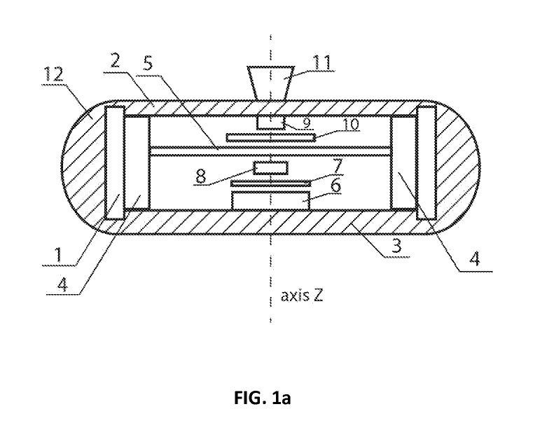

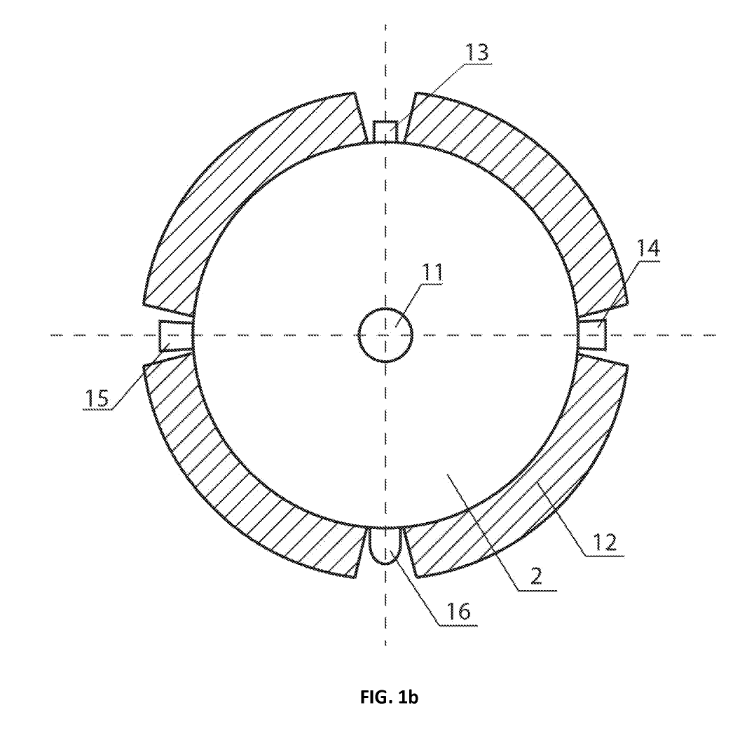

FIG. 1a illustrates a frontal sectional view of the bottom system, according to an embodiment of the present invention.

FIG. 1b illustrates a plan sectional view of the bottom system, according to the embodiment of the present invention shown in FIG. 1a.

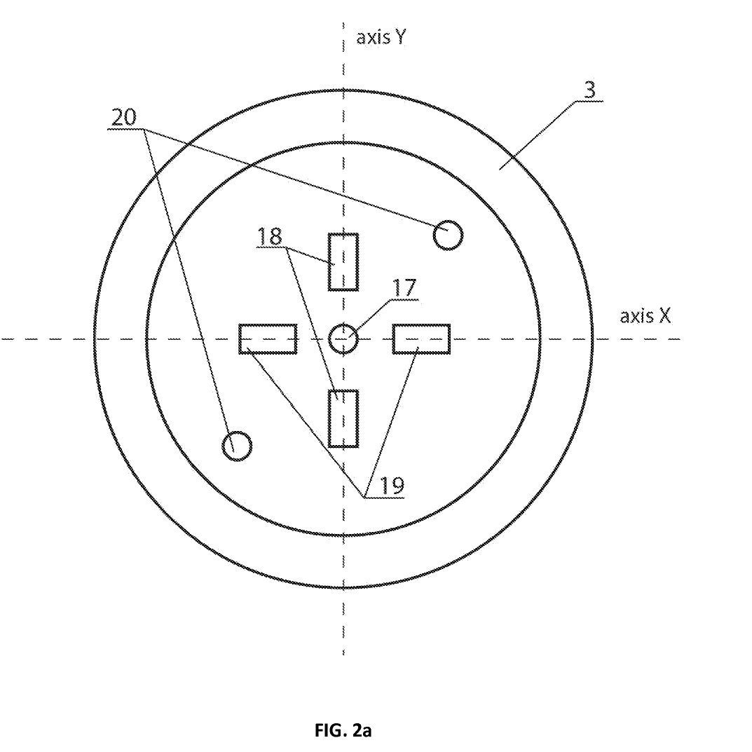

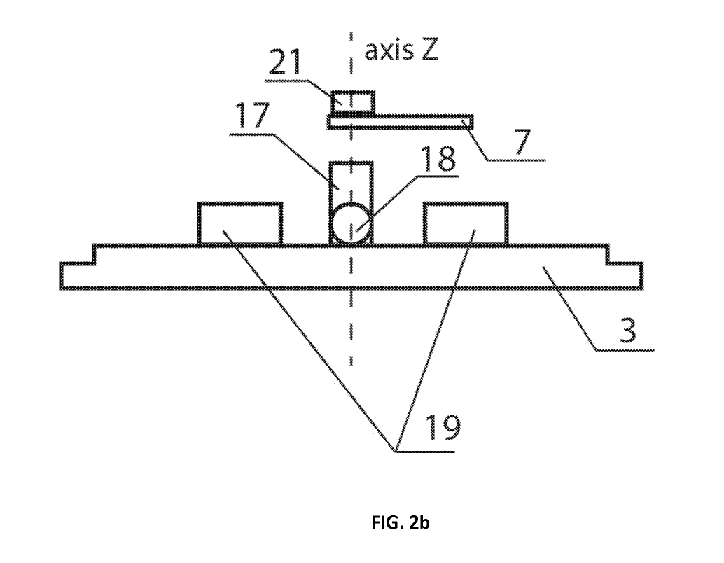

FIG. 2a illustrates a schematic plan view of location of essential units of the bottom system, according to the embodiment of the present invention shown in FIG. 1a.

FIG. 2b illustrates a schematic side view of location of essential units of the bottom system, according to the embodiment of the present invention shown in FIG. 1a.

### DESCRIPTION AND OPERATION OF PREFERRED INVENTIVE EMBODIMENTS

While the invention may be susceptible to embodiment in different forms, there are shown in the drawings, and will be described in detail herein, specific embodiments of the present invention, with the understanding that the present disclosure is to be considered an exemplification of the principles of the invention, and is not intended to limit the invention to that as illustrated and described herein.

An exemplary preferred embodiment of the present invention is illustrated in FIGS. 1a and 1b, showing a general composition of the units of the inventive bottom system. FIGS. 2a and 2b schematically show a disposition of geophones, power supply batteries, and an angle-detector.

As shown in FIGS. 1a, 1b, 2a and 2b, the bottom system's units are designated the following reference numerals/letters: 1—a case of the bottom system, 2—an upper lid of the bottom system, 3—a bottom of the bottom system (in embodiments, the bottom 3 can be combined as a whole with the sidewalls of the case 1), 4—a power supply unit, 5—a multi-channel registration unit, 6—a geophone block, 7—an angle-detector, 8—a vacuum sensor, 9—an external pressure sensor, 10—an electronic board of the acoustic system, 11—an acoustic antenna, 12—a protector layer, 13—a connector socket with a hermetic plug (cover), 14—a vacuum-port with a hermetic plug (cover), 15—a LED sensor with a hermetic plug (cover), 16—a hydrophone, 17—a vertical geophone, 18 and 19—two pairs of axially-symmetrical horizontal geophones, 20—a pair of axially-symmetrical batteries of the power supply unit, 21—a compass, X and Y—horizontal axes orthogonal to each other, and Z—a vertical axis of the bottom system.

In the preferred embodiment shown in FIGS. 1a, 1b, 2a and 2b, the inventive bottom system comprises:
a cylindrical case 1 (preferably made of non-magnetic material); the case includes sidewalls, an upper lid 2, and a bottom 3 (preferably being at least twice thicker than the upper lid 2 and the sidewalls);
a power supply unit 4 formed of a pair of rechargeable batteries 20, circumferentially located and pairwise symmetrical in relation to a vertical axis Z of the bottom system;
a geophone block 6 comprising five geophones for registration of transversal seismic waves, wherein a vertical geophone 17 registering the wave vertical component is mounted along the vertical axis Z, and two pairs of geophones 18 and 19 registering the wave horizontal components; wherein the geophones of pairs 18 and 19 are pairwise orthogonal-positioned being symmetrical in relation to the vertical axis Z; the geophone block 6 is rigidly mounted on the bottom 3 inside the case 1;
a multi-channel registration unit 5 serving for recording seismic data;
a compass 21 serving for producing an indication direction for orientation of the bottom system in the Earth magnetic field;
an angle-detector 7 associated with the compass 21 in such a way that the compass' indication direction essentially coincides with the axis of one pair of geophones 18 (see FIG. 2b), and the compass' center is located on the vertical axis Z; the angle-detector 7 is used for measuring of pitch, roll, and magnetic azimuth, and mounted coplanar to the plane of the bottom 3; the angle-detector 7 is capable of internal calibration for accounting the influence of magnetic masses of the bottom system's units;
a vacuum sensor 8 serving for control of the bottom system's water-tightness in the process of its preparation for operation, and during exploitation thereof;
an external pressure sensor 9 serving for control of the depth of placement of the bottom system on the seabed, and for registering of changes of the sea level during operation in tidal zones;
an acoustic system serving for determination of the bottom system's coordinates on the seabed, and for transferring information on the bottom system's condition and the noise level via an acoustic channel; the acoustic system comprises an electronic board 10 mounted inside the case 1, and connected with an acoustic antenna 11 mounted on the upper lid 2;
a hydrophone 16 mounted on the outer surface of the case 1;
a vacuum-port 14, mounted on the outer surface of the case 1;
a connector socket 13, mounted on the outer surface of the case 1, and serving for initialization of the bottom system, for data transferring from a flash memory of the multi-channel registration unit 5, and for recharging the power supply unit 4; and
a LED sensor 15, mounted on the outer surface of the case 1, and serving for control of the functional condition of the bottom system.

### Operation of a Preferred Embodiment of the Inventive Bottom System

The following steps are recommended to deploy a number of the bottom stations (systems) for seismic survey (see also U.S. Pat. No. 8,076,941, hereby incorporated by reference):
charging the power supply unit 4 through the connector socket 13 of each bottom station;
initializing each bottom station;
synchronizing the internal clocks, preferably via a pps-channel of the GPS system for each bottom station;
vacuuming up each bottom station through the vacuum-port 14;
controlling the hermetic condition of each bottom station and the charging process through the LED sensor 15;
the vacuum-port 14 and LED sensor 15 of each bottom station are closed with the hermetic plugs, and
the bottom stations are placed along the seabed profile for further survey thereof.

If the sea depth in the region of operation is greater than a half of distance between two neighbor bottom stations, then at least each tenth bottom station should be equipped with the aforementioned acoustic system having the board 10 and antenna 11 for control of positioning the bottom station on the seabed.

After the setting up the bottom stations on the seabed, the survey of the profile is provided and the bottom stations are then lifted on a vessel's board, wherein the synchronization clock of each bottom station is synchronized, via the connector socket 13, with the pps channel of the GPS system. Data from the flash memory of the registration unit 5 is transmitted to a base station. Based on the indication of the LED sensor 15, the hermetic condition and the extent of discharging the power supply unit are evaluated. Thereafter, the bottom station can be prepared to the next cycle of operation.

The bottom system allows registering different parameters of the seabed strata. The bottom system can operate within the sea depth range from 0 to 500 meters. The specific manner of setting the bottom stations on the seabed is determined based on the sea depth in the region to be surveyed, and on a predetermined distance between two neighbor bottom stations. Where the depth ranges from 20 to 100 meters, the bottom stations can be individually placed on the seabed, while each bottom station should be furnished with its own releasable load and a float for ascending the bottom station after operation. When the predetermined distance between the bottom stations is less than 20 meters, the bottom stations can be set by a chaplet with the help of halyard having a negative floatation.

We claim:

1. A sea bottom station for registration of seismic waves, having a vertical component and a horizontal component, said bottom seismic station is characterized with a vertical axis thereof;
said bottom station comprises the units of:
a submergible case including a bottom; and
a geophone block mounted within said case, said geophone block includes an odd plurality of geophones; wherein:
one of said geophones is a vertical geophone mounted essentially on said bottom along said vertical axis and capable of registering said vertical component;
the remaining said geophones are mounted essentially on said bottom and create pairs of geophones being pairwise orthogonal-positioned, while the geophones of each said pair are located symmetrically in relation to the vertical axis, and the remaining geophones are capable of registering said horizontal component.

2. The sea bottom station according to claim 1, wherein said case has a cylindrical shape and is made of essentially non-magnetic material; said case further comprising an upper lid and sidewalls; said bottom having a first thickness, said upper lid and said sidewalls having a second thickness, and wherein the first thickness is at least twice greater than the second thickness.

3. The sea bottom station according to claim 2, further comprising a power supply unit formed of a plurality of rechargeable batteries, circumferentially located and pairwise symmetrical in relation to said vertical axis.

4. The sea bottom station according to claim 1, further comprising a power supply unit formed of a plurality of rechargeable batteries, circumferentially located and pairwise symmetrical in relation to said vertical axis.

5. The sea bottom station according to claim 1, wherein one pair of said pairs of geophones is characterized with a pair axis; said bottom station further comprising:
a compass unit serving for producing an indication direction for orientation of said bottom system in the Earth magnetic field, said compass unit having a center; and
an angle-detector unit associated with the compass unit such that said indication direction essentially coincides with the pair axis, and the center of said compass unit is located on the vertical axis Z; the angle-detector unit is used for measuring of pitch, roll, and magnetic azimuth, and mounted coplanar to said bottom;
wherein the angle-detector unit is capable of internal calibration for accounting the influence of magnetic masses of the units of said bottom station.

6. The sea bottom station according to claim 3, wherein one pair of said pairs of geophones having a pair axis; said bottom station further comprising:
a compass unit serving for producing an indication direction for orientation of said bottom system in the Earth magnetic field, said compass unit having a center; and
an angle-detector unit associated with the compass unit such that said indication direction essentially coincides with the pair axis, and the center of said compass unit is located on the vertical axis Z; the angle-detector unit is used for measuring of pitch, roll, and magnetic azimuth, and mounted coplanar to said bottom;
wherein the angle-detector unit is capable of internal calibration for accounting the influence of magnetic masses of the units of said bottom station.

7. The sea bottom station according to claim 1, further comprising:
a vacuum sensor serving for control of water-tightness of the bottom station during preparation thereof to operation, and during exploitation thereof; and
an external pressure sensor serving for control of the depth of placement of said bottom station on the sea bottom, and for registering of changes of the sea level during operation of said bottom station in tidal zones.

8. The sea bottom station according to claim 3, further comprising:
a vacuum sensor serving for control of water-tightness of the bottom station during preparation thereof to operation, and during exploitation thereof; and
an external pressure sensor serving for control of the depth of placement of said bottom station on the sea bottom, and for registering of changes of the sea level during operation of said bottom station in tidal zones.

9. The sea bottom station according to claim 5, further comprising:
a vacuum sensor serving for control of water-tightness of the bottom station during preparation thereof to operation, and during exploitation thereof; and
an external pressure sensor serving for control of the depth of placement of said bottom station on the sea bottom, and for registering of changes of the sea level during operation of said bottom station in tidal zones.

10. The sea bottom station according to claim 6, further comprising:
a vacuum sensor serving for control of water-tightness of the bottom station during preparation thereof to operation, and during exploitation thereof; and
an external pressure sensor serving for control of the depth of placement of said bottom station on the sea bottom, and for registering of changes of the sea level during operation of said bottom station in tidal zones.

11. The sea bottom station according to claim 1, wherein said case further including an upper lid; said bottom station further comprising:
an acoustic system serving for determination of coordinates of said bottom station on the seabed, and for transferring information on current conditions of said bottom station and on a noise level; said acoustic system includes an electronic board mounted inside the case, and connected with an acoustic antenna mounted on the upper lid.

12. The sea bottom station according to claim 3, wherein said case further including an upper lid; said bottom station further comprising:
an acoustic system serving for determination of coordinates of said bottom station on the seabed, and for transferring information on current conditions of said bottom station and on a noise level; said acoustic system includes an electronic board mounted inside the case, and connected with an acoustic antenna mounted on the upper lid.

13. The sea bottom station according to claim 5, wherein said case further including an upper lid; said bottom station further comprising:
an acoustic system serving for determination of coordinates of said bottom station on the seabed, and for transferring information on current conditions of said bottom station and on a noise level; said acoustic system includes an electronic board mounted inside the case, and connected with an acoustic antenna mounted on the upper lid.

14. The sea bottom station according to claim 6, wherein said case further including an upper lid; said bottom station further comprising:
an acoustic system serving for determination of coordinates of said bottom station on the seabed, and for transferring information on current conditions of said bottom station and on a noise level; said acoustic system includes an electronic board mounted inside the case, and connected with an acoustic antenna mounted on the upper lid.

15. The sea bottom station according to claim 9, wherein said case further including an upper lid; said bottom station further comprising:
an acoustic system serving for determination of coordinates of said bottom station on the seabed, and for transferring information on current conditions of said bottom station and on a noise level; said acoustic system includes an electronic board mounted inside the case, and connected with an acoustic antenna mounted on the upper lid.

16. The sea bottom station according to claim 10, wherein said case further including an upper lid; said bottom station further comprising:
an acoustic system serving for determination of coordinates of said bottom station on the seabed, and for transferring information on current conditions of said bottom station and on a noise level; said acoustic system includes an electronic board mounted inside the case, and connected with an acoustic antenna mounted on the upper lid.

17. The sea bottom station according to claim 1, wherein said case further defining an outer surface; said bottom station further comprising:
a multi-channel registration unit mounted within said case, said multi-channel registration unit including a flash memory;
a connector socket, mounted on said outer surface, and serving for initialization of the bottom station, for data transferring from the flash memory, and for recharging the power supply unit; and
a LED sensor, mounted on said outer surface, and serving for control of functional conditions of the bottom station.

18. The sea bottom station according to claim 6, wherein said case further defining an outer surface; said bottom station further comprising:
a multi-channel registration unit mounted within said case, said multi-channel registration unit including a flash memory;
a connector socket, mounted on said outer surface, and serving for initialization of the bottom station, for data transferring from the flash memory, and for recharging the power supply unit; and
a LED sensor, mounted on said outer surface, and serving for control of functional conditions of the bottom station.

19. The sea bottom station according to claim 7, wherein said case further defining an outer surface; said bottom station further comprising:
a multi-channel registration unit mounted within said case, said multi-channel registration unit including a flash memory;
a connector socket, mounted on said outer surface, and serving for initialization of the bottom station, for data transferring from the flash memory, and for recharging the power supply unit; and
a LED sensor, mounted on said outer surface, and serving for control of functional conditions of the bottom station.

20. The sea bottom station according to claim 11, wherein said case further defining an outer surface; said bottom station further comprising:
a multi-channel registration unit mounted within said case, said multi-channel registration unit including a flash memory;
a connector socket, mounted on said outer surface, and serving for initialization of the bottom station, for data transferring from the flash memory, and for recharging the power supply unit; and
a LED sensor, mounted on said outer surface, and serving for control of functional conditions of the bottom station.
